(19) United States
(12) Patent Application Publication
(10) Pub. No.: US 2016/0095033 A1
(43) Pub. Date: Mar. 31, 2016

(54) METHOD TO OPTIMIZE LTE DATA PERFORMANCE FOR SINGLE RADIO HYBRID TUNE AWAY DEVICES THROUGH DISCARD TIMER

(71) Applicant: QUALCOMM Incorporated, San Diego, CA (US)

(72) Inventors: Prasad KADIRI, San Diego, CA (US); Pavan KAIVARAM, San Diego, CA (US); Neelakanta Venkata Seshachalam CHIMMAPUDI, San Diego, CA (US); Ammar Taiyebi KITABI, San Diego, CA (US); Chintan Shirish SHAH, San Diego, CA (US); Aziz GHOLMIEH, Del Mar, CA (US)

(21) Appl. No.: 14/863,118

(22) Filed: Sep. 23, 2015

Related U.S. Application Data
(60) Provisional application No. 62/056,167, filed on Sep. 26, 2014.

(51) Int. Cl. H04W 36/14; H04L 12/823; H04W 36/24

(52) U.S. Cl. CPC H04W 36/14; H04W 36/24; H04L 47/32

(57) ABSTRACT

A method, an apparatus, and a computer program product for wireless communication are provided. The apparatus, e.g., UE, suspends a discarding process of data packets associated with a first RAT during tune away by the UE to a second RAT by stopping a discard timer. The UE restarts the discarding process in response to an occurrence of a triggering event. The triggering event may occur when the UE tunes back to the first RAT, or when a duration of the UE tune away to the second RAT exceeds a threshold. The discarding process may be restarted by resuming the discard timer at the point in time where it was stopped or by resetting the timer to zero.

### CROSS-REFERENCE TO RELATED APPLICATION(S)

This application claims the benefit of U.S. Provisional Application Ser. No. 62/056,167, entitled “Method to Optimize LTE Data Performance for Single Radio Hybrid Tune Away Devices through Discard Timer” and filed on Sep. 26, 2014, which is expressly incorporated by reference herein in its entirety.

### BACKGROUND

1. Field

The present disclosure relates generally to communication systems, and more particularly, to a method to optimize LTE data performance for single radio hybrid tune away devices through discard timer.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). LTE is designed to better support mobile broadband Internet access by improving spectral efficiency, lowering costs, improving services, making use of new spectrum, and better integrating with other open standards using OFDMA on the downlink (DL), SC-FDMA on the uplink (UL), and multiple-input multiple-output (MIMO) antenna technology, etc. However, as the demand for mobile broadband access continues to increase, there exists a need for further improvements in LTE technology. Preferably, these improvements should be applicable to other multi-access technologies and the telecommunication standards that employ these technologies.

### SUMMARY

A method, an apparatus, and a computer program product for wireless communication are provided. The apparatus, e.g., UE, suspends a discarding process of data packets associated with a first RAT during tune away by the UE to a second RAT by stopping a discard timer. The UE restarts the discarding process in response to an occurrence of a triggering event. The triggering event may occur when the UE tunes back to the first RAT, or when a duration of the UE tune away to the second RAT exceeds a threshold. The discarding process may be restarted by resuming the discard timer at the point in time where it was stopped or by resetting the timer to zero.

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control planes.

FIG. 6 is a diagram illustrating an example of an evolved Node B (eNB) and user equipment (UE) in an access network.

FIG. 7 is a diagram illustrating an exemplary deployment in which multiple wireless networks have overlapping coverage.

FIG. 8 is a diagram illustrating a system that implements a data packet discard process based on discard timers.

FIG. 9 is a diagram illustrating a user plane protocol stack for a UE and an eNB.

FIG. 10 is a diagram illustrating transmission and reception of data packets by a PDCP layer.

FIG. 11 is a flow chart of a method of discarding data packets based on discard timers.

FIG. 12 is a flow chart of a method of wireless communication.

FIG. 13 is a conceptual data flow diagram illustrating the data flow between different components in an exemplary apparatus.

FIG. 14 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), compact disk ROM (CD-ROM) or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

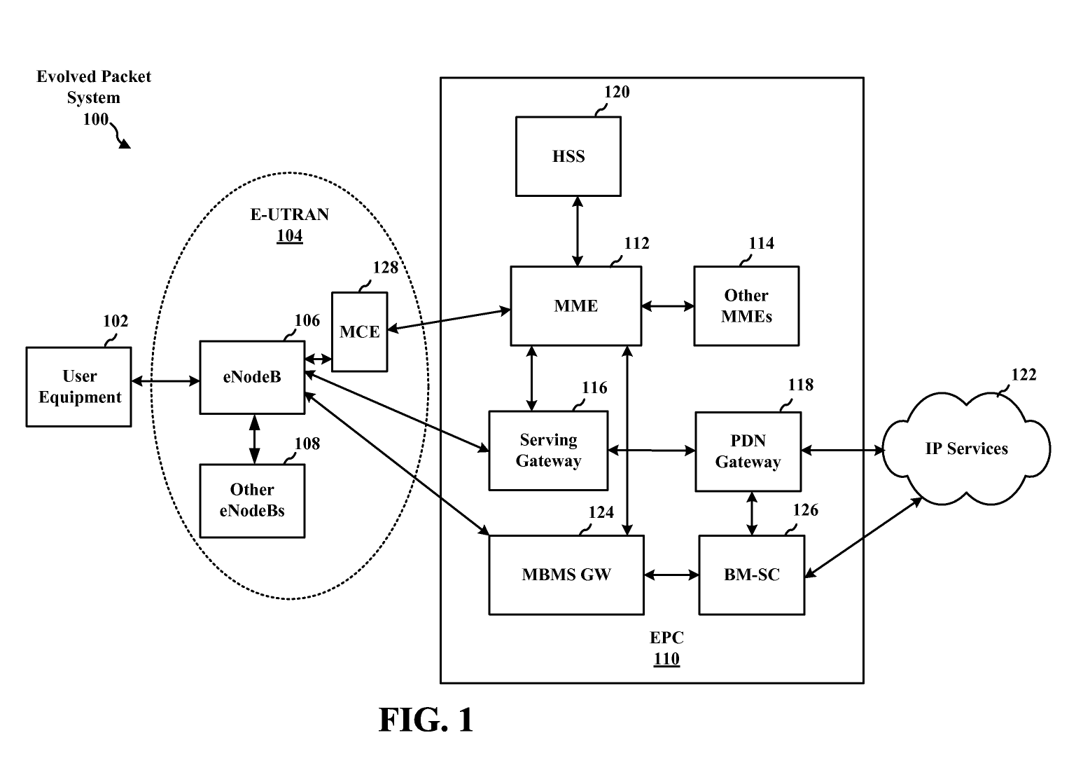

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, and an Operator's Internet Protocol (IP) Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108, and may include a Multicast Coordination Entity (MCE) 128. The eNB 106 provides user and control planes protocol terminations toward the UE 102. The eNB 106 may be connected to the other eNBs 108 via a backhaul (e.g., an X2 interface). The MCE 128 allocates time/frequency radio resources for evolved Multimedia Broadcast Multicast Service (MBMS) (eMBMS), and determines the radio configuration (e.g., a modulation and coding scheme (MCS)) for the eMBMS. The MCE 128 may be a separate entity or part of the eNB 106. The eNB 106 may also be referred to as a base station, a Node B, an access point, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected to the EPC 110. The EPC 110 may include a Mobility Management Entity (MME) 112, a Home Subscriber Server (HSS) 120, other MMEs 114, a Serving Gateway 116, a Multimedia Broadcast Multicast Service (MBMS) Gateway 124, a Broadcast Multicast Service Center (BM-SC) 126, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 and the BM-SC 126 are connected to the IP Services 122. The IP Services 122 may include the Internet, an intranet, an IP Multimedia Subsystem (IMS), a PS Streaming Service (PSS), and/or other IP services. The BM-SC 126 may provide functions for MBMS user service provisioning and delivery. The BM-SC 126 may serve as an entry point for content provider MBMS transmission, may be used to authorize and initiate MBMS Bearer Services within a PLMN, and may be used to schedule and deliver MBMS transmissions. The MBMS Gateway 124 may be used to distribute MBMS traffic to the eNBs (e.g., 106, 108) belonging to a Multicast Broadcast Single Frequency Network (MBSFN) area broadcasting a particular service, and may be responsible for session management (start/stop) and for collecting eMBMS related charging information.

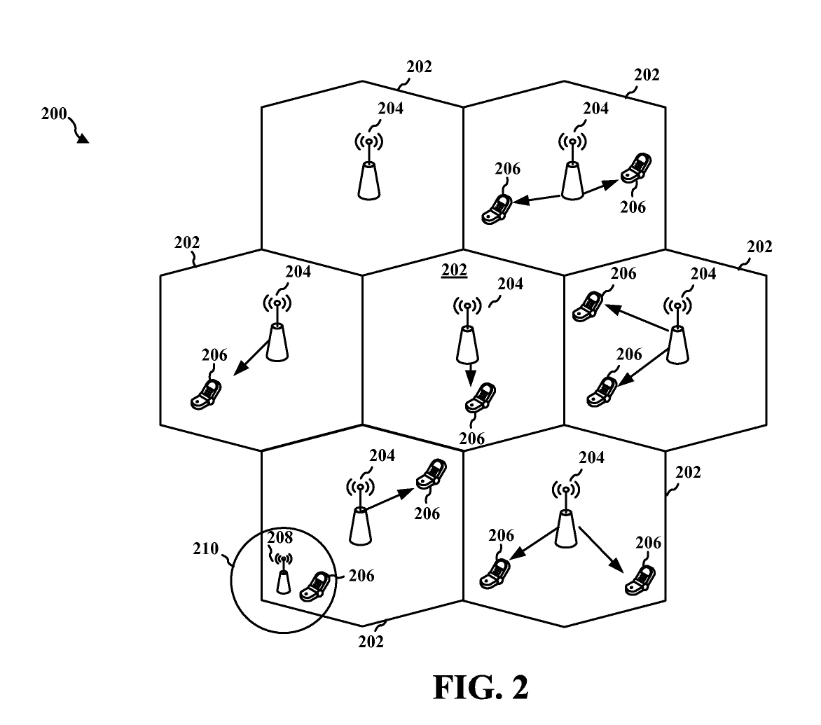

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. The lower power class eNB 208 may be a femto cell (e.g., home eNB (HeNB)), pico cell, micro cell, or remote radio head (RRH). The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116. An eNB may support one or multiple (e.g., three) cells (also referred to as a sectors). The term “cell” can refer to the smallest coverage area of an eNB and/or an eNB subsystem serving are particular coverage area. Further, the terms “eNB,” “base station,” and “cell” may be used interchangeably herein.

The modulation and multiple access scheme employed by the access network 200 may vary depending on the particular telecommunications standard being deployed. In LTE applications, OFDM is used on the DL and SC-FDMA is used on the UL to support both frequency division duplex (FDD) and time division duplex (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data streams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

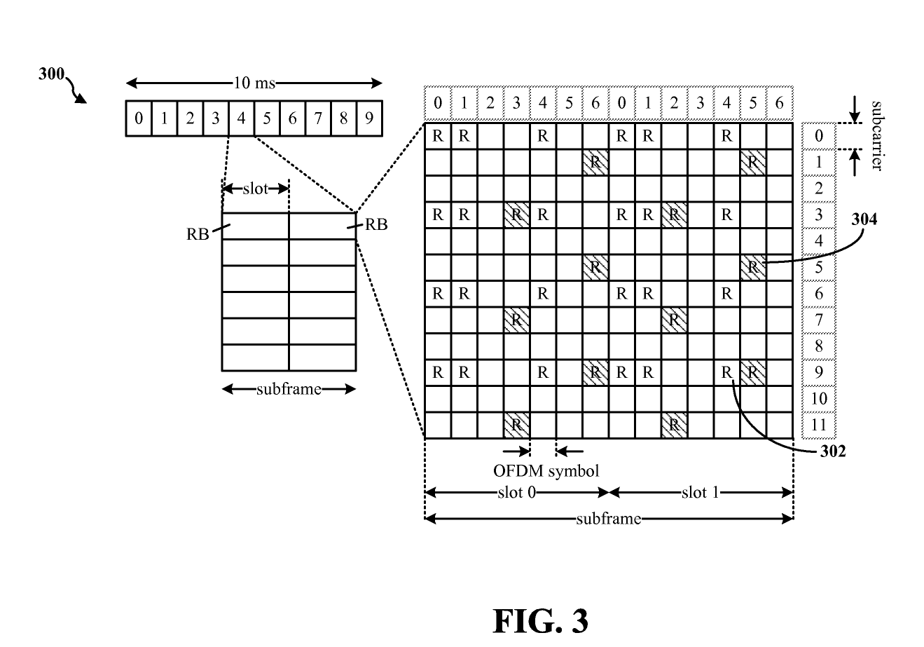

FIG. 3 is a diagram 300 illustrating an example of a DL frame structure in LTE. A frame (10 ms) may be divided into 10 equally sized subframes. Each subframe may include two consecutive time slots. A resource grid may be used to represent two time slots, each time slot including a resource block. The resource grid is divided into multiple resource elements. In LTE, for a normal cyclic prefix, a resource block contains 12 consecutive subcarriers in the frequency domain and 7 consecutive OFDM symbols in the time domain, for a total of 84 resource elements. For an extended cyclic prefix, a resource block contains 12 consecutive subcarriers in the frequency domain and 6 consecutive OFDM symbols in the time domain, for a total of 72 resource elements. Some of the resource elements, indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

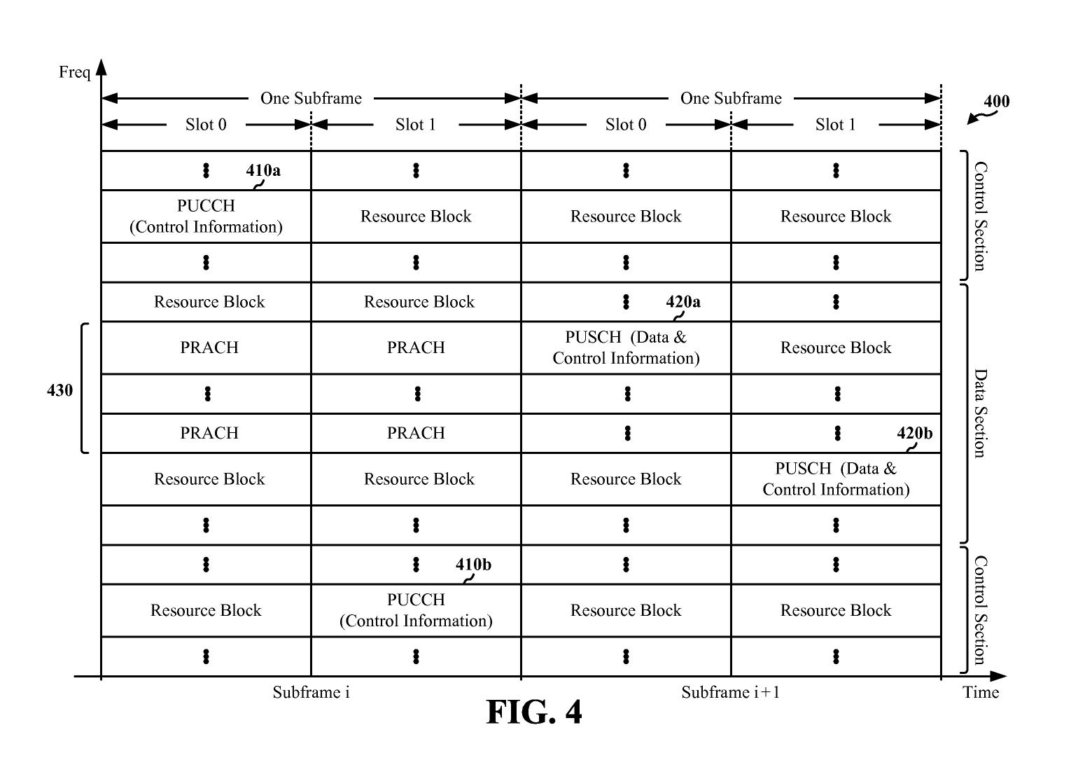

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

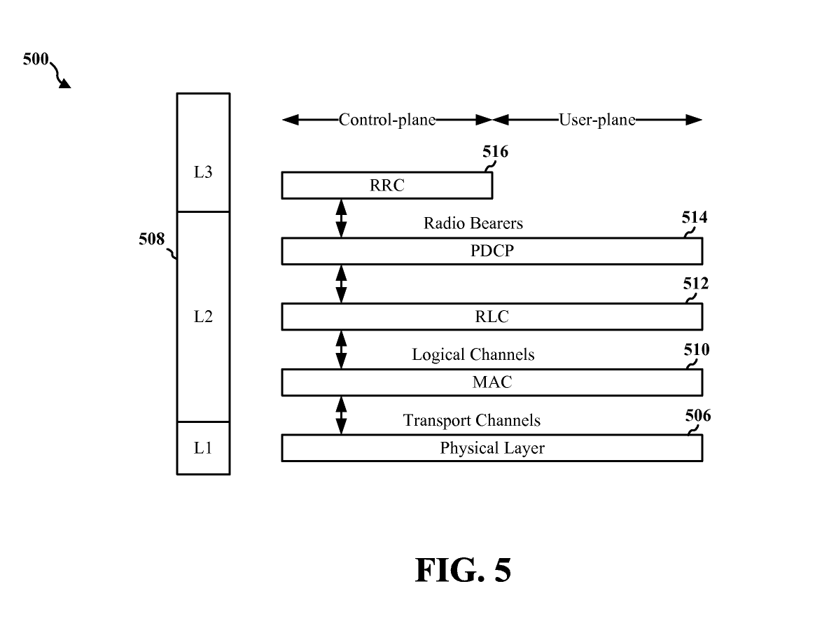

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (e.g., radio bearers) and for configuring the lower layers using RRC signaling between the eNB and the UE.

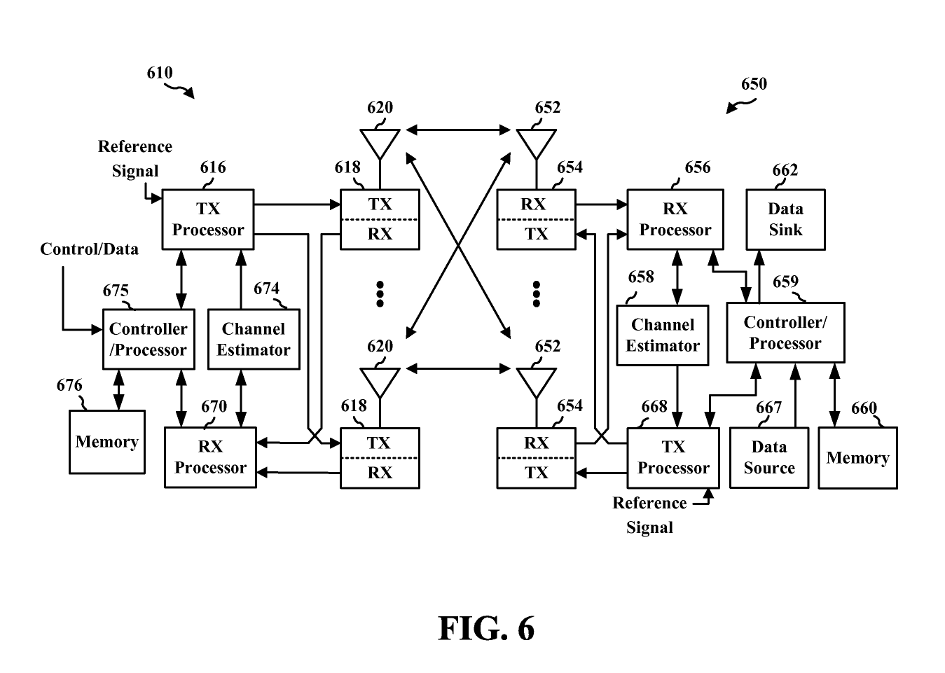

FIG. 6 is a block diagram of an eNB 610 in communication with a UE 650 in an access network. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The transmit (TX) processor 616 implements various signal processing functions for the L1 layer (i.e., physical layer). The signal processing functions include coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream may then be provided to a different antenna 620 via a separate transmitter 618TX. Each transmitter 618TX may modulate an RF carrier with a respective spatial stream for transmission.

At the UE 650, each receiver 654RX receives a signal through its respective antenna 652. Each receiver 654RX recovers information modulated onto an RF carrier and provides the information to the receive (RX) processor 656. The RX processor 656 implements various signal processing functions of the L1 layer. The RX processor 656 may perform spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 may be provided to different antenna 652 via separate transmitters 654TX. Each transmitter 654TX may modulate an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the controller/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

Certain techniques have been designed to provide wireless device operational modes that comply with requirements established for operations on certain frequency bands of radio access networks (RANs). One such technique involves a wireless device receiving voice service from a legacy network (e.g., a CDMA 2000 1× or simply “1×” network) which provides service that geographically overlaps the service of an enhanced network, e.g., a long term evolution (LTE) network.

In networks that support both LTE and CDMA, it may be necessary for the UE chipset to support both LTE and CDMA 1×. There may be two system architectures to support monitoring 1× while operating in LTE. The first architecture may have two separate radio frequency (RF) chains, one for LTE and the other for 1×. This architecture may allow for 1× voice pages to be decoded in parallel when LTE data calls are active. This architecture/algorithm is generally referred to as SVLTE (simultaneous voice and LTE).

Another architecture may have just one RF chain. This RF chain may have to be shared between LTE and 1×, with a constraint that LTE and CDMA technologies may not be active simultaneously. In order to monitor 1× paging, the UE may have to periodically tune away from LTE while an LTE data call is active. While the one RF chain architecture improves battery consumption, saves board area and bill of material (BOM), a problem may arise when the UE has to periodically monitor 1× voice pages while an LTE data call is active. During the RF-tune time to 1×, the LTE call is suspended or virtually suspended, and this may lead to disruption in LTE UE function.

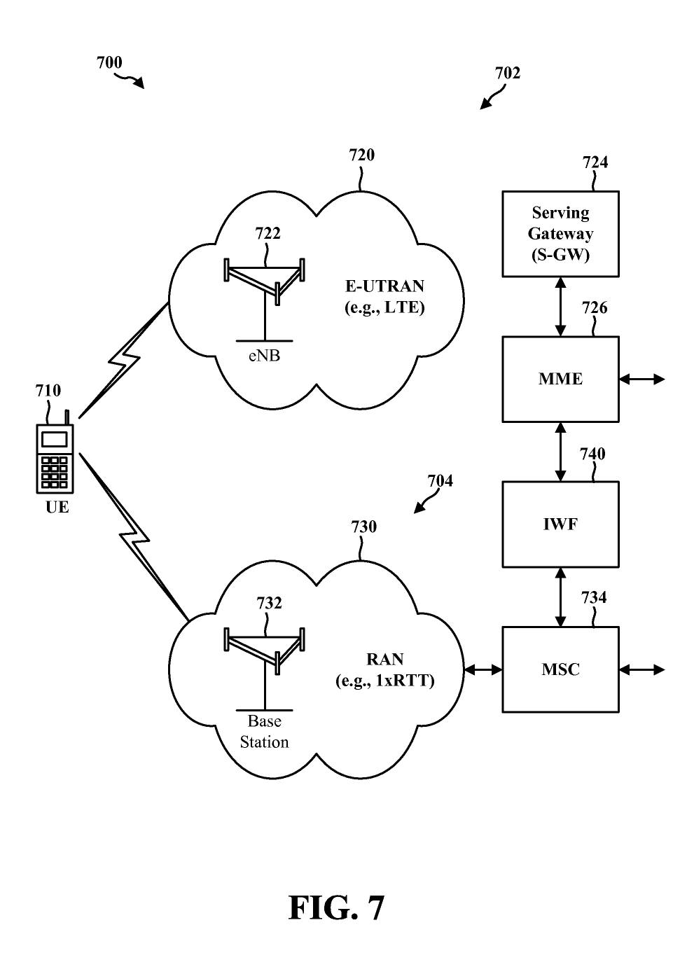

FIG. 7 shows an exemplary deployment in which multiple wireless networks have overlapping coverage. An evolved universal terrestrial radio access network (E-UTRAN) 720 may support LTE and may include a number of eNBs 722 and other network entities that can support wireless communication for UEs. Each eNB may provide communication coverage for a particular geographic area. The term “cell” can refer to a coverage area of an eNB and/or an eNB subsystem serving this coverage area. A serving gateway (S-GW) 724 may communicate with E-UTRAN 720 and may perform various functions such as packet routing and forwarding, mobility anchoring, packet buffering, initiation of network triggered services, etc. A MME 726 may communicate with E-UTRAN 720 and serving gateway 724 and may perform various functions such as mobility management, bearer management, distribution of paging messages, security control, authentication, gateway selection, etc.

A radio access network (RAN) 730 may support 1×RTT and may include a number of base stations 732 and other network entities that can support wireless communication for UEs. A mobile switching center (MSC) 734 may communicate with the RAN 730 and may support voice services, provide routing for circuit-switched calls, and perform mobility management for UEs located within the area served by MSC 734. An inter-working function (IWF) 740 may facilitate communication between MME 726 and MSC 734.

E-UTRAN 720, serving gateway 724, and MME 726 may be part of an LTE network 702. RAN 730 and MSC 734 may be part of a 1×RTT network 704. For simplicity, FIG. 7 shows only some network entities in the LTE network and the 1×RTT network. The LTE and 1×RTT networks may also include other network entities that may support various functions and services.

Upon power up, UE 710 may search for wireless networks from which it can receive communication services. If more than one wireless network is detected, then a wireless network with the highest priority may be selected to serve UE 710 and may be referred to as the serving network. UE 710 may perform registration with the serving network, if necessary. UE 710 may then operate in a connected mode to actively communicate with the serving network. Alternatively, UE 710 may operate in an idle mode and camp on the serving network if active communication is not required by UE 710.

UE 710 may be located within the coverage of cells of multiple frequencies and/or multiple RATs while in the idle mode. For LTE, UE 710 may select a frequency and a RAT to camp on based on a priority list. This priority list may include a set of frequencies, a RAT associated with each frequency, and a priority assigned to each frequency. UE 710 may be configured to prefer LTE, when available, by defining the priority list with LTE frequencies at the highest priority and with frequencies for other RATs at lower priorities, e.g., as given by the example above.

UE 710 may operate in the idle mode as follows. UE 710 may identify all frequencies/RATs on which it is able to find a “suitable” cell in a normal scenario or an “acceptable” cell in an emergency scenario, where “suitable” and “acceptable” are specified in the LTE standards. UE 710 may then camp on the frequency/RAT with the highest priority among all identified frequencies/RATs. UE 710 may remain camped on this frequency/RAT until either (i) the frequency/RAT is no longer available at a predetermined threshold or (ii) another frequency/RAT with a higher priority reaches this threshold.

UE 710 may be able to receive packet-switched (PS) data services from LTE network 702 and may camp on the LTE network while in the idle mode. LTE network 702 may have limited or no support for voice-over-Internet protocol (VoIP), which may often be the case for early deployments of LTE networks. Due to the limited VoIP support, UE 710 may be transferred to another wireless network of another RAT for voice calls. This transfer may be referred to as circuit-switched (CS) fallback. UE 710 may be transferred to a RAT that can support voice service such as 1×RTT, WCDMA, GSM, etc. For call origination with CS fallback, UE 710 may initially become connected to a wireless network of a source RAT (e.g., LTE) that may not support voice service. The UE may originate a voice call with this wireless network and may be transferred through higher-layer signaling to another wireless network of a target RAT that can support the voice call. The higher-layer signaling to transfer the UE to the target RAT may be for various procedures, e.g., connection release with redirection, PS handover, etc.

As noted above, in some cases, it may be desirable for a UE to operate with a single RF chain, for example, to reduce cost, reduce size, and limit power consumption. In such cases, the single RF chain may be shared between multiple RAT networks, for example, an LTE network for packet switched (PS) service and a 1× network for circuit switched (CS) service. Therefore, it may not be possible for LTE and 1× technologies (e.g., CDMA, GSM, or UMTS) to be active at the same time.

Issues may arise when a UE tunes away from a first RAT, such as LTE, to a second RAT, such as 1×, while an LTE data call is active. For example, uplink LTE data may be subject to timer-based discards by the UE during tune away, resulting in degradation of LTE data performance.

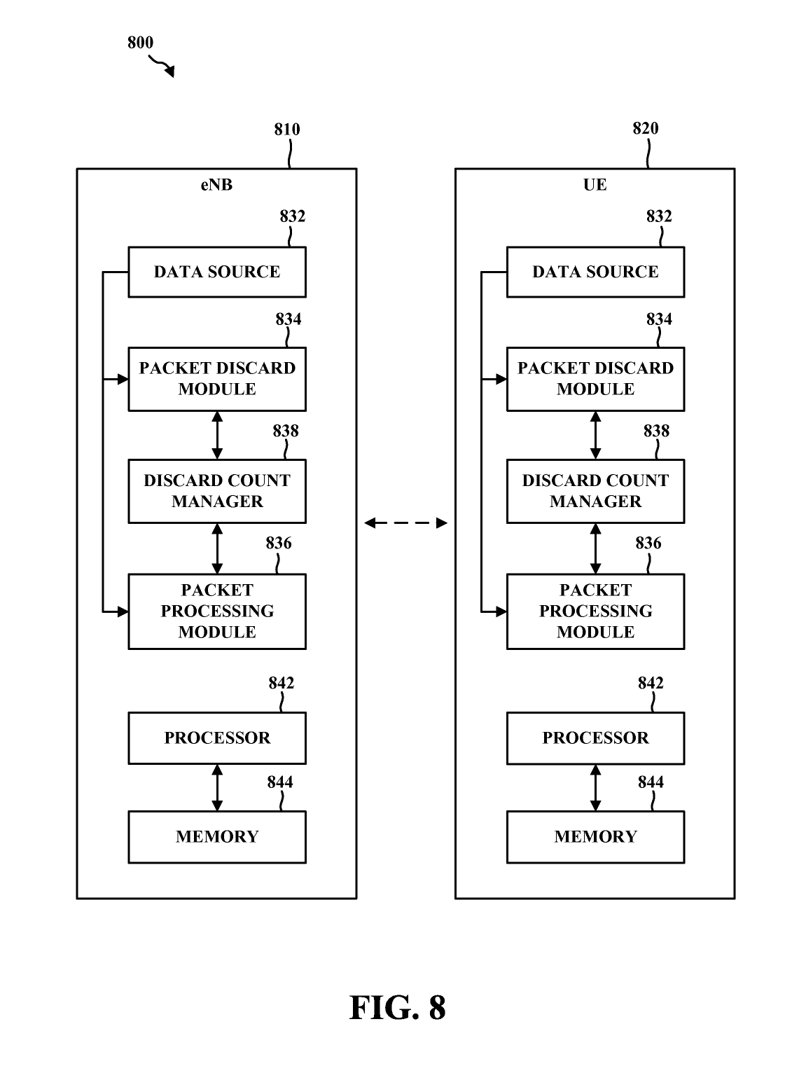

FIG. 8 is a diagram illustrating a system 800 that implements a data packet discard process based on discard timers. The system 800 may include an eNB 810, which can communicate with one or more UEs 820. The eNB 810 and UE 820 may communicate data, control signaling, and/or other information between each other and/or other entities in system 800 in the form of respective packets, such as packet data convergence protocol (PDCP) protocol data units (PDUs), service data units (SDUs). For example, a processor 842 at eNB 810 and/or UE 820 can, either independently or with the aid of a memory 844, generate one or more packets to be transmitted within system 800. Additionally or alternatively, a memory 844 at eNB 810 and/or UE 820 can be utilized to store respective packets or corresponding information before, during, or after respective transmissions.

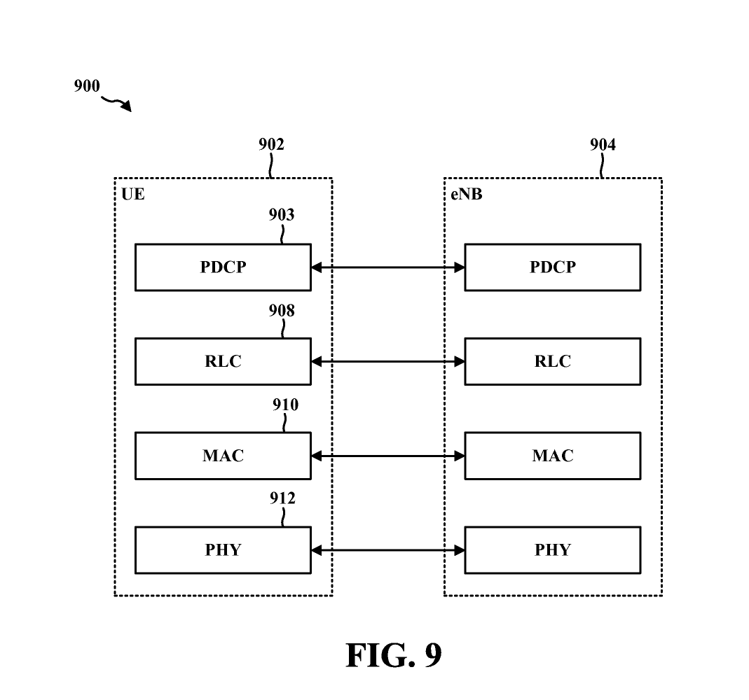

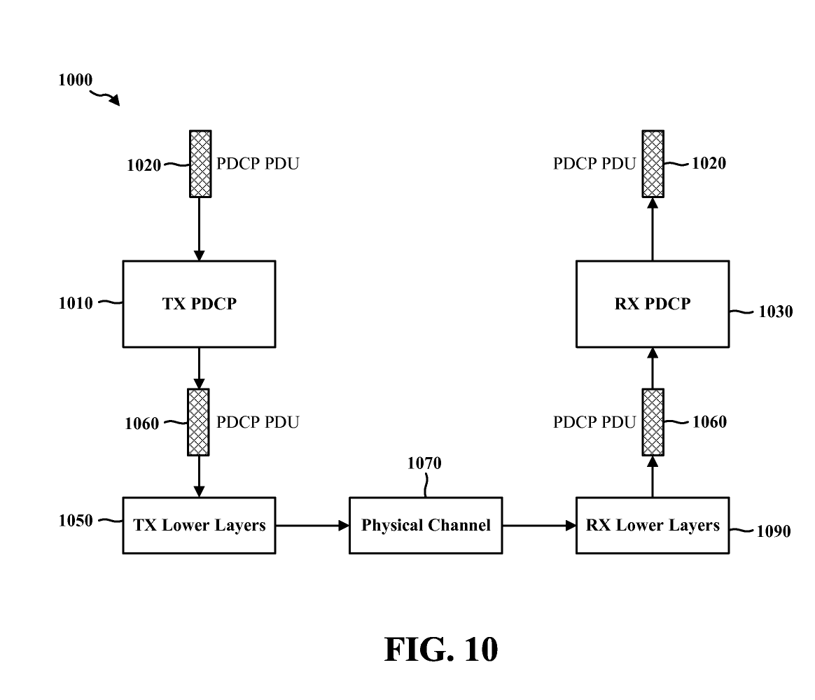

Transmission of respective packets within system 800 can be accomplished via the use of one or more PDCP layer mechanisms as described below with reference to FIGS. 9 and 10. For example, a data source 832 can be configured to queue respective PDCP SDUs and/or other information elements at the PDCP layer for subsequent transmission via an associated transmitter (not shown) and/or processing via a packet processing component 836.

FIG. 9 is a diagram 900 illustrating a user plane protocol stack for a UE 902 and an eNB 904. The protocol stack may include a PDCP layer 906, a RLC layer 908, a MAC layer 910 and a physical (PHY) layer 912. The physical layer performs the physical transport of data between the UE and the eNB.

In the transmitter side, each layer receives SDUs from a higher layer, adds headers to the SDUs to generate PDUs, and sends the PDUs to a lower layer. The PDUs are treated as SDUs by the lower layer. For a typical data transmission, the PDCP layer receives packets (PDCP SDU) from an upper layer and processes them into PDCP PDUs which are submitted to a lower layer. Similarly, on the receiver side, the PDCP layer receives packets (PDCP PDUs) from a lower layer and extracts a PDCP SDU for further processing at the upper layer.

As generally used in the following description, an SDU is any packet that is received from an upper layer in the transmitter side or passed to an upper layer in the receiver side, whereas a PDU is a packet generated by a layer and passed on to a lower layer in the transmitter side or received from a lower layer in the receiver side. Therefore, for example, a PDCP PDU is an RLC SDU in the transmitter side. Similarly, an RLC PDU is a MAC SDU, and so forth.

FIG. 10 is a diagram 1000 illustrating transmission and reception of data packets by a PDCP layer. At the transmitter side, the PDCP layer 1010 receives a packet (PDCP SDU 1020) for processing from an upper layer. The PDCP layer 1010 processes the packet into a PDCP PDU 1060 which may be submitted to a lower layer 1050. The packet may then be transmitted through a physical channel 1070. In this architecture, a single PDCP PDU 1060 is generated from exactly one PDCP SDU 1020.

Similarly, on the receiver side, the PDCP layer receives a packet (PDCP PDU 1060) from a lower layer 1090 and extracts the PDCP SDU 1020 to send to an upper layer for further processing. Since the mapping between the PDCP PDU and PDCP SDU is a one-to-one relationship, every PDCP SDU is generated from exactly one PDCP PDU.

Returning to FIG. 8, a packet discard component 834 can be implemented at eNB 810 and/or UE 820 in order to increase the overall efficiency of communication within system 800 by providing timer-based packet discard functionality for respective SDUs. More particularly, packet discard component 834 can be configured with respective discard timers corresponding to respective PDCP entities (e.g., radio bearers, communication channels, etc.) on which packet discard is configured. In one example, packet discard component 834 can independently compute respective discard timers. Additionally or alternatively, packet discard component 834 can receive information relating to respective discard timers from a local processor 842, a network controller and/or another network entity associated with system 800, and/or any other suitable source. In one example, respective discard timers can be set for a given radio bearer and/or other PDCP entity based on various factors, such as an application type associated with the PDCP entity, quality of service (QoS) or latency requirements associated with the PDCP entity and/or an application utilizing the PDCP entity, or the like.

Upon configuration of a discard timer for a given PDCP entity, packet discard component 834 can be configured to start the discard timer for respective PDCP SDUs and/or other packets that are queued for transmission on the corresponding PDCP entity. Subsequently, if the discard timer associated with a PDCP entity expires prior to transmission of a SDU for which the discard timer was started, the SDU can be regarded as stale and discarded by packet discard component 834 in order to save the over-the-air bandwidth associated with transmission of the stale SDU. Similarly, if it is determined that a PDCP PDU corresponding to the discarded SDU has already been submitted to one or more lower layers, e.g., RLC layer, associated with packet processing component 836 and/or any other suitable components of eNB 810 and/or UE 820, the discard can be indicated to the appropriate lower layers.

In current standards related to the LTE protocol stack, such as 3GPP TS 36.323, a PDCP protocol defines a PDCP discard timer to support uplink flow control of data coming from upper layers. With reference to FIG. 10, when a data packet 1020 enters from an upper layer to a PDCP data buffer of the PDCP layer 1010, the UE PDCP protocol starts a PDCP discard timer for that data packet 1020. Upon expiration of the discard timer for a PDCP SDU 1020, or upon successful delivery of a PDCP SDU, as confirmed by PDCP status report, the UE discards the PDCP SDU 1020 from the data buffer.

During LTE uplink data transfer for hybrid tune away devices, PDCP SDUs 1020 may be discarded during tune away due to expiration of the discard timer. This may cause loss of data and may require retransmission of same data packets, thereby resulting in degradation of LTE uplink data performance.

The significance of LTE uplink data loss due to timer expiration may depend on cell conditions. For example, if a UE tuned to LTE is located at the edge of a cell, the UE may receive smaller uplink grants from the eNB due to limited bandwidth at the cell edge. As a result, the byte rate of PDCP SDUs 1020 entering the data buffer of the PDCP layer 1010 from the upper layer may be greater that the byte rate of data packets exiting the lower layers 1050 to the physical channel 1070. Accordingly, the PDCP SDUs become backed up in the data buffer. Upon tune away from LTE, the PDCP SDUs remain in the buffer and are thus subject to discard due to timer expiration. The significance of LTE uplink data loss due to timer expiration may also depend on the frequency and duration of tune aways.

In order to minimize the impact to the LTE data performance due to tune away, certain aspects of the present disclosure provide techniques for implementing behavioral changes at the UE during tune away. More specifically, this disclosure provides UE based discard process enhancements during tune away that improve LTE data throughput performance.

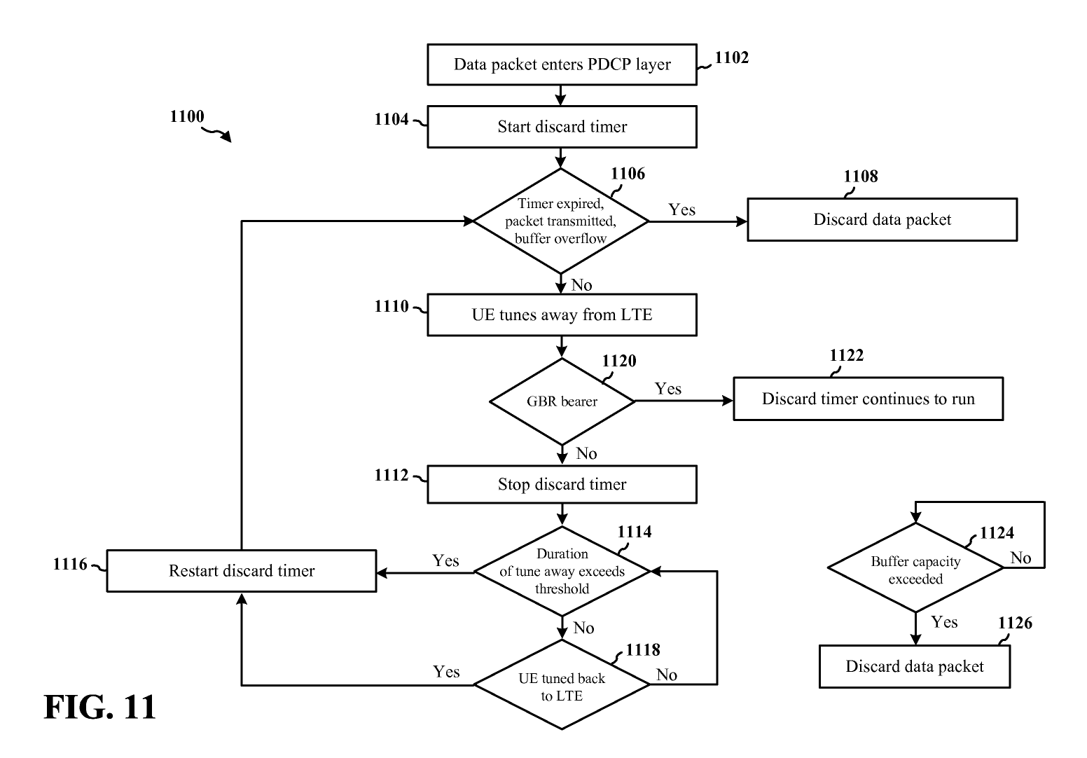

FIG. 11 is a flow chart 1100 of a method of discarding data packets, e.g., PDCP SDUs, based on discard timers. The method may be performed by a UE. At step 1102, a PDCP SDU 1020 enters into a data buffer of the PDCP layer 1010 of PDCP protocol stack. At step 1104, the PDCP layer 1010 starts a discard timer. At step 1106, the PDCP layer 1010 monitors for one or more of: 1) expiration of the discard timer, 2) an indication that the PDCP SDU 1020 has been submitted to a lower layer 1050 in a PDCP PDU 1060, and 3) overflow of the data buffer, i.e., capacity of data buffer is exceeded. If any of these conditions occur, the process proceeds to step 1108 where the PDCP layer 1010 discards the PDCP SDU 1020.

If none of these conditions occur, the process may proceed to step 1110 where the UE may tune away from LTE while the discard timer is running. The lower layer 1050 of the UE sends a tune away start indication to the PDCP layer 1010. The duration of a typical tune away may be between 100-150 msec. During this time, there is an interruption of uplink LTE data transfer. Thus, the PDCP SDUs 1020 remains in the data buffer of the PDCP layer 1010.

At step 1120, in response to the tune away by the UE, the PDCP layer 1010 determines whether the bit rate provided by the bearer associated with the PDCP layer is guaranteed bit rate (GBR) bearer or a non-GBR bearer. In LTE, minimum GBR bearers and non-GBR bearers may be provided. Minimum GBR bearers are typically used for real time applications like Voice over Internet Protocol (VoIP), radiotelephony, video, gaming applications, with an associated GBR value. Non-GBR bearers do not guarantee any particular bit rate, and are typically used for applications such as web-browsing. If the bearer is a GBR bearer, the process proceeds to step 1122 where the discard timer continues to run so as not to adversely affect the performance of real-time application. This is beneficial in that it prevents real-time LTE data from backing up in the PDCP layer 1010 data buffer, which otherwise could cause data buffer overflow when the UE tunes back to LTE and the real-time LTE application resumes. If the bearer is a non-GBR bearer, the process proceeds to step 1122 where the PDCP layer 1010 stops the discard timer so that the PDCP SDUs are not discarded.

At step 1114, the PDCP layer 1010 monitors the duration of the tune away by the UE and compares it to a threshold. If the duration of the tune away exceeds the threshold, the process proceeds to step 1116, where the PDCP layer 1010 restarts the discard timer. Normal range of tune away is 100-150 msec. If the UE is tuning away for too long a period of time, e.g. one second, the timer may be restarted. For example, a threshold time may be set to 500 msec. If the UE is tuned away for longer than the threshold, the discard timer is restarted and the process returns to step 1106. This threshold based restart of the timer is beneficial in that it prevents LTE data from backing up in the PDCP layer 1010 data buffer, which otherwise could cause data buffer overflow when the UE tunes back to LTE and the LTE application resumes.

Returning to step 1116, the discard timer may be restarted by either resuming the timer where it left off or resetting the timer to zero. For example, in the case of timer resumption and a discard timer of 200 msec, if the UE tune away occurs 50 msec after the start of the discard timer, the discard timer resumes at 51 msec, leaving 149 msec remaining before expiration of the timer. In the case of timer reset, the discard timer is reset to zero msec, leaving 150 msec before expiration of the timer.

Returning to step 1114, if the duration of the tune away does not exceed the threshold, the process proceeds to step 1118, where the PDCP layer 1010 monitors for an indication that the UE has tuned back to LTE. To this end, the lower layer 1050 of the UE may send a tune away stop indication to the PDCP layer 1010 indicating that the UE has tuned back to LTE. If the UE has tuned back to LTE, the process proceeds to step 1116, where the PDCP layer 1010 restarts the discard timer, as previously described. If the UE has not tuned back to LTE the process returns to step 1114.

During tune away by the UE and while the discard timer is stopped, the UE may at step 1124 continually monitor the state of the data buffer to determine if the capacity of the buffer has been exceeded. If the capacity has been exceeded, the UE may at step 1126 discard one or more data packets until buffer capacity if no longer exceeded. This monitoring of buffer capacity by the UE is performed in parallel with monitoring the duration of tune away at step 1114 and monitoring for tune back by the UE at step 1118.

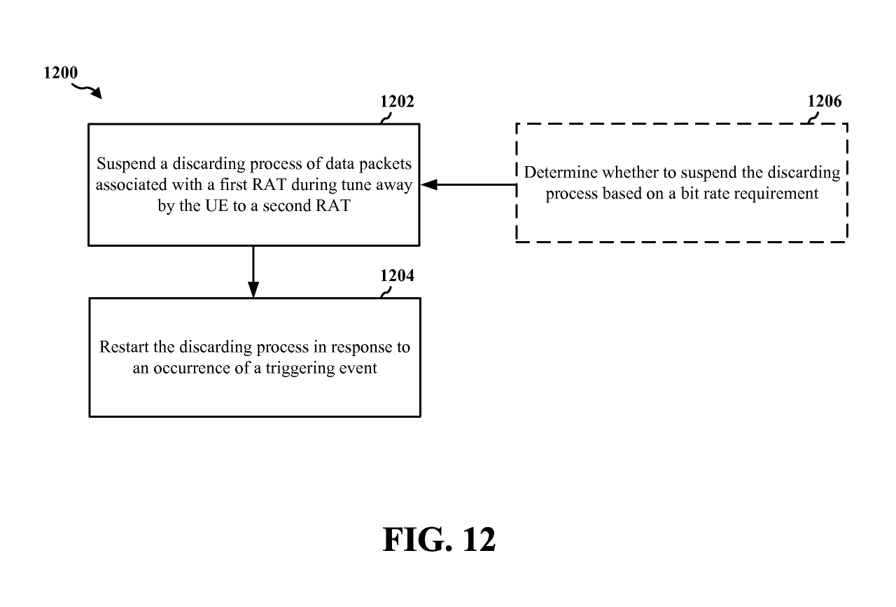

FIG. 12 is a flow chart 1200 of a method of wireless communication. The method may be performed by a UE. At step 1202, the UE suspends a discarding process of data packets, such as PDCP SDUs, associated with a first RAT, e.g., LTE, during tune away by the UE to a second RAT, e.g., 1×RTT, GSM, TD-SCDMA or other 3G technologies. The discarding process may be suspended by stopping the discard timer. The discard timer may be stopped immediately upon tune away by the UE to the second RAT, or perhaps some time thereafter.

At step 1204, the UE restarts the discarding process in response to an occurrence of a triggering event. Restarting the discarding process may include resuming the discard timer at the time the discard timer was stopped, or resetting the discard timer to a time less than the time the discard timer was stopped. For example, the discard timer may be reset to zero.

In one configuration, the triggering event that restarts the discarding process may occur when the UE tunes back to the first RAT. In another configuration, the triggering event that restarts the discarding process may occur when a duration of the UE tune away to the second RAT exceeds a threshold. In this case, the discarding process is restarted while the UE is still tuned away to the second RAT, and restarting the discarding process at 1204 includes discarding data packets associated with the first RAT during tune away by the UE to the second RAT when a capacity of a buffer storing the data packets associated with the first RAT is exceeded.

The data packets associated with the first RAT may be associated with an application having a bit rate requirement. Accordingly, the UE may at step 1206 determine whether to suspend the discarding process associated with data packets associated with the first RAT based on the bit rate requirement. For example, the discarding process may be suspended only when the UE determines that the bit rate requirement corresponds to a non guaranteed bit rate.

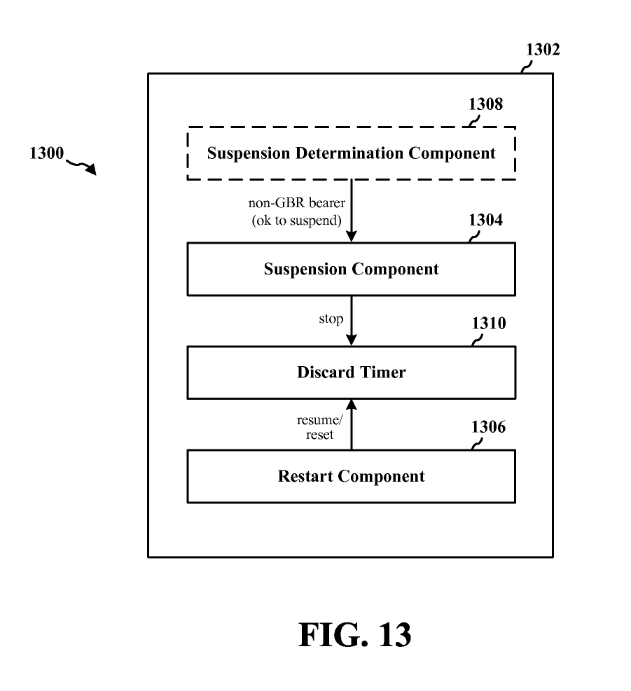

FIG. 13 is a conceptual data flow diagram 1300 illustrating the different components in an exemplary apparatus 1302. The apparatus 1302 may be a UE. The apparatus includes a suspension component 1304, a restart component 1306, a suspension determination component 1308, and a discard timer 1310.

The suspension component 1304 is configured to suspend a discarding process of data packets associated with a first RAT during tune away by the UE 1302 to a second RAT. To this end, the suspension component 1304 may monitor for a tune away start indication from a lower layer 1050 of the UE and a PDCP layer 1010 of the UE. The suspension component 1304 may suspend the discarding process by stopping the discard timer 1310.

The restart component 1306 is configured to restart the discarding process in response to an occurrence of a triggering event. To this end, the restart component 1306 monitors for a trigger event, which may be one or more of the UE 1302 tuning back to the first RAT, and a duration of the UE tune away to the second RAT exceeding a threshold. Upon occurrence of a triggering event, the restart component 1306 may restart the discarding process by resuming the discard timer 1310 at the time the discard timer was stopped or resetting the discard timer to a time less than the time the discard timer was stopped. The restart component 1306 may be further configured to initiate the discarding of data packets associated with the first RAT during tune away by the UE 1302. For example, the restart component 1306 may be configured to determine when the capacity of a buffer storing the data packets associated with the first RAT is exceeded.

The optional suspension determination component 1308 is configured to determine whether to suspend the discarding process associated with the data packets of the first RAT based on a bit rate requirement. To this end, the suspension determination component 1308 may determine, based on the type of application being used by the UE at the time of tune away, whether GBR bearers or non-GBR bearers are involved. If non-GBR bearers are involved the suspension determination component 1308 determines to suspend the discarding process and indicates such determination to the suspension component 1304.

The apparatus 1302 may include additional components that perform each of the steps of the algorithm/process in the aforementioned flowcharts of FIG. 11 and FIG. 12. As such, each step in the aforementioned flowcharts of FIG. 11 and FIG. 12 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

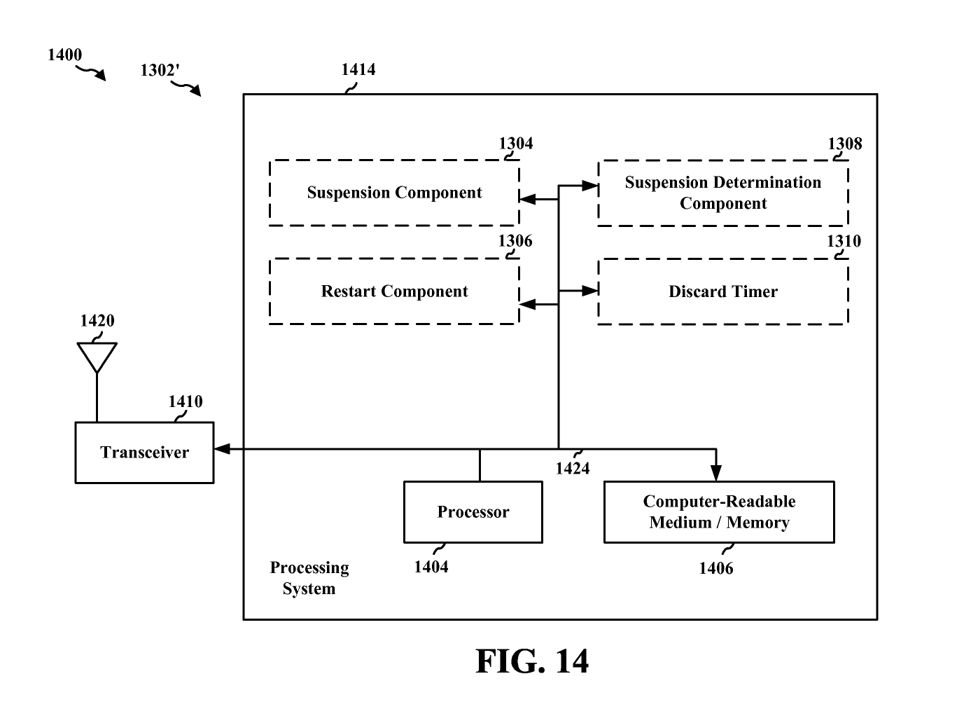

FIG. 14 is a diagram 1400 illustrating an example of a hardware implementation for an apparatus 1302′ employing a processing system 1414. The processing system 1414 may be implemented with a bus architecture, represented generally by the bus 1424. The bus 1424 may include any number of interconnecting buses and bridges depending on the specific application of the processing system 1414 and the overall design constraints. The bus 1424 links together various circuits including one or more processors and/or hardware components, represented by the processor 1404, the components 1304, 1306, 1308, 1310 and the computer-readable medium/memory 1406. The bus 1424 may also link various other circuits such as timing sources, peripherals, voltage regulators, and power management circuits, which are well known in the art, and therefore, will not be described any further.

The processing system 1414 may be coupled to a transceiver 1410. The transceiver 1410 is coupled to one or more antennas 1420. The transceiver 1410 provides a means for communicating with various other apparatus over a transmission medium. The transceiver 1410 receives a signal from the one or more antennas 1420, extracts information from the received signal, and provides the extracted information to the processing system 1414. In addition, the transceiver 1410 receives information from the processing system 1414, and based on the received information, generates a signal to be applied to the one or more antennas 1420.

The processing system 1414 includes a processor 1404 coupled to a computer-readable medium/memory 1406. The processor 1404 is responsible for general processing, including the execution of software stored on the computer-readable medium/memory 1406. The software, when executed by the processor 1404, causes the processing system 1414 to perform the various functions described supra for any particular apparatus. The computer-readable medium/memory 1406 may also be used for storing data that is manipulated by the processor 1404 when executing software.

The processing system further includes at least one of the components 1304, 1306, 1308, 1310. The components may be software modules running in the processor 1404, resident/stored in the computer readable medium/memory 1406, one or more hardware components coupled to the processor 1404, or some combination thereof. The processing system 1414 may be a component of the UE 650 and may include the memory 660 and/or at least one of the TX processor 668, the RX processor 656, and the controller/processor 659.

In one configuration, the apparatus 1302/1302′ for wireless communication includes means for suspending a discarding process of data packets associated with a first RAT during tune away by the UE to a second RAT, means for restarting the discarding process in response to an occurrence of a triggering event, and means for discarding data packets associated with the first RAT during tune away by the UE to the second RAT when a capacity of a buffer storing the data packets associated with the first RAT is exceeded.

The aforementioned means may be one or more of the aforementioned components of the apparatus 1302 and/or the processing system 1414 of the apparatus 1302′ configured to perform the functions recited by the aforementioned means. As described supra, the processing system 1414 may include the TX Processor 668, the RX Processor 656, and the controller/processor 659. As such, in one configuration, the aforementioned means may be the TX Processor 668, the RX Processor 656, and the controller/processor 659 configured to perform the functions recited by the aforementioned means.

It is understood that the specific order or hierarchy of steps in the processes/flow charts disclosed is an illustration of exemplary approaches. Based upon design preferences, it is understood that the specific order or hierarchy of steps in the processes/flow charts may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of wireless communication of a user equipment (UE), comprising:
suspending a discarding process of data packets associated with a first radio access technology (RAT) during tune away by the UE to a second RAT; and
restarting the discarding process in response to an occurrence of a triggering event.

2. The method of claim 1, wherein suspending a discarding process of data packets associated with a first RAT comprises stopping a discard timer.

3. The method of claim 2, wherein the discard timer is stopped upon tune away by the UE to the second RAT.

4. The method of claim 2, wherein restarting the discarding process comprises resuming the discard timer at the time the discard timer was stopped.

5. The method of claim 2, wherein restarting the discarding process comprises resetting the discard timer to a time less than the time the discard timer was stopped.

6. The method of claim 1, wherein the triggering event occurs when the UE tunes back to the first RAT.

7. The method of claim 1, wherein the triggering event occurs when a duration of the UE tune away to the second RAT exceeds a threshold.

8. The method of claim 1, wherein restarting the discarding process comprises discarding data packets associated with the first RAT during tune away by the UE to the second RAT when a capacity of a buffer storing the data packets associated with the first RAT is exceeded.

9. The method of claim 1, wherein the data packets associated with the first RAT are associated with an application having a bit rate requirement, and further comprising determining to suspend the discarding process associated with data packets associated with the first RAT based on the bit rate requirement.

10. The method of claim 9, wherein the discarding process is suspended when the bit rate requirement corresponds to a non guaranteed bit rate.

11. The method of claim 1, wherein the first RAT corresponds to long term evolution (LTE) and the second RAT corresponds to one of 1×RTT, GSM, TD-SCDMA or other 3G technologies.

12. The method of claim 1, wherein the data packets correspond to packet data convergence protocol (PDCP) service data units (SDUs).

13. An apparatus for wireless communication, comprising:
means for suspending a discarding process of data packets associated with a first radio access technology (RAT) during tune away by the UE to a second RAT; and
means for restarting the discarding process in response to an occurrence of a triggering event.

14. The apparatus of claim 13, wherein the means for suspending a discarding process of data packets associated with a first RAT is configured to stop a discard timer.

15. The apparatus of claim 14, wherein the discard timer is stopped upon tune away by the UE to the second RAT.

16. The apparatus of claim 14, wherein the means for restarting the discarding process is configured to resume the discard timer at the time the discard timer was stopped.

17. The apparatus of claim 14, wherein the means for restarting the discarding process is configured to reset the discard timer to a time less than the time the discard timer was stopped.

18. The apparatus of claim 13, wherein the triggering event occurs when the UE tunes back to the first RAT.

19. The apparatus of claim 13, wherein the triggering event occurs when a duration of the UE tune away to the second RAT exceeds a threshold.

20. The apparatus of claim 13, wherein the means for restarting the discarding process is configured to discard data packets associated with the first RAT during tune away by the UE to the second RAT when a capacity of a buffer storing the data packets associated with the first RAT is exceeded.

21. The apparatus of claim 13, wherein the data packets associated with the first RAT are associated with an application having a bit rate requirement, and further comprising means for determining to suspend the discarding process associated with data packets associated with the first RAT based on the bit rate requirement.

22. The apparatus of claim 21, wherein the discarding process is suspended when the bit rate requirement corresponds to a non guaranteed bit rate.

23. The apparatus of claim 13, wherein the first RAT corresponds to long term evolution (LTE) and the second RAT corresponds to one of 1×RTT, GSM, TD-SCDMA or other 3G technologies.

24. The apparatus of claim 13, wherein the data packets correspond to packet data convergence protocol (PDCP) service data units (SDUs).

25. An apparatus for wireless communication, comprising:
a memory; and
at least one processor coupled to the memory and configured to:
suspend a discarding process of data packets associated with a first radio access technology (RAT) during tune away by the UE to a second RAT; and
restart the discarding process in response to an occurrence of a triggering event.

26. The apparatus of claim 25, wherein the at least one processor is configured to suspend a discarding process of data packets associated with a first RAT by stopping a discard timer.

27. The apparatus of claim 25, wherein the triggering event occurs when the UE tunes back to the first RAT.

28. The apparatus of claim 25, wherein the triggering event occurs when a duration of the UE tune away to the second RAT exceeds a threshold.

29. The apparatus of claim 25, wherein the at least one processor is configured to restart the discarding process by discarding data packets associated with the first RAT during tune away by the UE to the second RAT when a capacity of a buffer storing the data packets associated with the first RAT is exceeded.

30. A computer-readable medium storing computer executable code for wireless communication, comprising code for:
suspending a discarding process of data packets associated with a first radio access technology (RAT) during tune away by the UE to a second RAT; and
restarting the discarding process in response to an occurrence of a triggering event.
